(19) United States
(12) Patent Application Publication
(10) Pub. No.: US 2025/0224922 A1
(43) Pub. Date: Jul. 10, 2025

(54) MANTISSA ALIGNMENT

(71) Applicant: Taiwan Semiconductor Manufacturing Company, Ltd., Hsinchu (TW)

(72) Inventors: Win-San KHWA, Hsinchu (TW); Hung-Hsi HSU, Hsinchu (TW); Xiaochen PENG, Hsinchu (TW); Murat Kerem Akarvardar, Hsinchu (TW); Meng-Fan Chang, Hsinchu (TW)

(21) Appl. No.: 18/644,550

(22) Filed: Apr. 24, 2024

Related U.S. Application Data
(60) Provisional application No. 63/617,557, filed on Jan. 4, 2024.

(51) Int. Cl. G06F 7/487

(52) U.S. Cl. CPC G06F 7/487

(57) ABSTRACT

In some embodiments, a computing method includes, for a set of products, each of a respective pair of a first and a second floating-point operands, each having a respective mantissa and exponent, aligning the mantissas of the first operands based on a maximum exponent of the first operands to generate a shared exponent; modifying the mantissas of the first operands based on the shared exponent to generate respective adjusted mantissas of the first operands; generating mantissa products, each based on the mantissa of a respective one of the second operands and a respective one of the adjusted first mantissas retrieved from the memory device; summing the mantissas products to generate a mantissa product partial sum; and combining the shared exponent and the product mantissa partial sum. The adjusted mantissas of the first operands can be saved in, and retrieved from, a memory device for the mantissa product generation.

### CROSS REFERENCE TO RELATED APPLICATIONS

This application claims the benefit of U.S. Provisional Application Ser. No. 63/617,557, filed Jan. 4, 2024, which provisional application is incorporated herein by reference in its entirety.

### BACKGROUND

This disclosure relates generally to floating-point arithmetic operations in computing devices, for example, in in-memory computing, or compute-in-memory (“CIM”) devices and application-specific integrated circuits (“ASICs”), and further relates to methods and devices used data processing, such as multiply-accumulate (“MAC”) operations. Compute-in-memory or in-memory computing systems store information in the main random-access memory (RAM) of computers and perform calculations at memory cell level, rather than moving large quantities of data between the main RAM and data store for each computation step. Because stored data is accessed much more quickly when it is stored in RAM, compute-in-memory allows data to be analyzed in real time. ASICs, include digital ASICs, are designed to optimize data processing for specific computational needs. The improved computational performance enables faster reporting and decision-making in business and machine learning applications. Efforts are ongoing to improve the performance of such computational memory systems, and more specifically floating-point arithmetic operations in such systems.

### BRIEF DESCRIPTION OF THE DRAWINGS

Aspects of the present disclosure are best understood from the following detailed description when read with the accompanying drawings. It is noted that, in accordance with the standard practice in the industry, various features are not drawn to scale. In fact, the dimensions of the various features may be arbitrarily increased or reduced for clarity of discussion. In addition, the drawings are illustrative as examples of embodiments of the invention and are not intended to be limiting.

FIG. 1 outlines a method for a multiply-accumulate (“MAC”) operation according to some embodiments.

FIG. 2A outlines a mothed of processing floating-point operands, such as weight values used in MAC operations, prior to multiplication, in accordance with some embodiments.

FIG. 2B schematically illustrates floating-point operands, such as weight values used in MAC operations, as well as their respective storage, in accordance with some embodiments.

FIGS. 3A and 3B schematically illustrate an example MAC operation on floating-point operands, such as weight values and input activations, in accordance with some embodiments.

FIG. 4 illustrate storage bit reduction as a result of employing pre-multiplication mantissa alignment in MAC operations, in accordance with some embodiments.

FIG. 5 outlines a method for a multiply-accumulate (“MAC”) operation, in which the MAC operation on a set of input activation-weight value pairs is divided into MAC operations on two or more subgroups, with the MAC operation on each subgroup carried out as outlined in FIG. 1, and the output of the MAC operations further aligned and summed, in accordance with some embodiments.

FIG. 6 schematically illustrates a CIM device configured to carry out MAC operations, in accordance with some embodiments.

FIG. 7A outlines a mothed of processing floating-point operands, such as input activations used in MAC operations, prior to multiplication, in accordance with some embodiments.

FIG. 7B schematically illustrates floating-point operands, such as input activations, used in MAC operations, as well as their respective storage, in accordance with some embodiments.

FIG. 8 outlines a method for a multiply-accumulate (“MAC”) operation according to some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the drawings. The spatially relative terms are intended to encompass different orientations of the device in use or operation in addition to the orientation depicted in the drawings. The apparatus may be otherwise oriented (rotated 90 degrees or at other orientations) and the spatially relative descriptors used herein may likewise be interpreted accordingly.

This disclosure relates generally to floating-point arithmetic operations in computing devices, for example, in in-memory computing, or compute-in-memory (“CIM”) devices and application-specific integrated circuits (“ASICs”), and further relates to methods and devices used data processing, such as multiply-accumulate (“MAC”) operations. Computer artificial intelligence (“AI”) uses deep learning techniques, where a computing system may be organized as a neural network. A neural network refers to a plurality of interconnected processing nodes that enable the analysis of data, for example. Neural networks use “weights” to perform computation on new input data. Neural networks use multiple layers of computational nodes, where deeper layers perform computations based on results of computations performed by higher layers.

CIM circuits perform operations locally within a memory without having to send data to a host processor. This may reduce the amount of data transferred between memory and the host processor, thus enabling higher throughput and performance. The reduction in data movement also reduces energy consumption of overall data movement within the computing device.

Alternatively, MAC operations can be implemented in other types of system, such as a computer system programmed to carry out MAC operations.

In certain embodiments disclosed in the present disclosure, a computing method includes, for a set of products, each of a respective pairs of a first and a second floating-point operands, such as a weight value (or “weight”) and an input value (or “input activation”), respectively, in multiply-accumulate operations, each of the floating-point operands having a respective mantissa and exponent, aligning the exponents of first floating-point operands based on a maximum exponent of the first floating-point operands to generate a shared exponent; modifying the mantissas of the first floating-point operands based on the shared exponent to generate respective adjusted mantissas of the first floating-point operands; generating mantissa products, each based on the mantissa of a respective one of the second floating-point operands and a respective one of the adjusted first mantissas; summing the mantissas products to generate a mantissa product partial sum; and combining the shared exponent and the product mantissa partial sum. The adjusted mantissas of the first floating-point operands can be saved in a memory device and retrieved from the memory device for the mantissa product generation. The product mantissa partial sum can be used in a neural network system. The multiplication can be performed in a computer-in-memory macro (“CIM macro”), and the alignment of the mantissas of at least one of the first and second floating-point operands can be carried out offline and the adjusted (aligned) mantissas pre-stored in the CIM macro.

In further embodiments, a computer method includes the steps described above and further includes, before the multiplication step, aligning the exponents of second floating-point operands based on a maximum exponent of the second floating-point operands to generate a shared exponent; modifying the mantissas of the second floating-point operands based on the shared exponent to generate respective adjusted mantissas of the second floating-point operands. The summing of the mantissa products is then carried out by directly summing the mantissas of the mantissa products without any further alignment (because the input-weight products have the same exponents).

In some embodiments, a computing method includes, for a set of products, each of a respective pairs of a first and a second floating-point operands, such as an input activation and a weight value, respectively, in multiply-accumulate operations, each of the floating-point operands having a respective mantissa and exponent, aligning the exponents of first floating-point operands based on a maximum exponent of the first floating-point operands to generate a shared exponent; modifying the mantissas of the first floating-point operands based on the shared exponent to generate respective adjusted mantissas of the first floating-point operands; generating mantissa products, each based on the mantissa of a respective one of the second floating-point operands and a respective one of the adjusted first mantissas; modifying the mantissa products based on the shared exponent to generate respective adjusted mantissas mantissa products; summing the adjusted mantissa products to generate a mantissa product partial sum; and combining the shared exponent and the product mantissa partial sum. The adjusted mantissas of the first floating-point operands can be saved in a memory device and retrieved from the memory device for the mantissa product generation. The product mantissa partial sum can be used in a neural network system.

According to some embodiments, a device for carrying out the method described above include one or more digital circuits, such as microprocessors, shift registers, binary multipliers and adders, and comparators, configured to implement the steps of the method, and memory devices configured store the output of the digital circuits. In some embodiments, mantissa adjustments are carried out by shifting the mantissas stored in registers. In some embodiments, the multiplication is carried out in CIM macros, where the mantissas of the first floating-point numbers (e.g., weight values) are stored in a CIM memory array connected to a logic circuit, and the mantissas of the second floating-point number (e.g., input activations) are applied to the logic circuit, which outputs digital signal indicative of products of the mantissas.

In a MAC operation, a set of input numbers are each multiplied by a respective one of a set of weight values (or weights), which may be stored in a memory array. The product are then accumulated, i.e., added together to form an output number. In certain applications, such as neural networks used in machine learning in AI, the output resulted from MAC operation can be used as a new weight value in the next iteration of MAC operation in a succeeding layer of the neural network. An example of the mathematical description of the MAC operation is shown below.

$${O}_{J} = {\sum }_{I = 1}^{h - 1} ( {A}_{I} \times {W}_{IJ} ) , \qquad ( 1 )$$

where A_{I} is the I-th input, W_{IJ} is the weight corresponding to the I-th input and J-th weight column. O_{J} is the MAC output of the J-th weight column, and h is the accumulated number.

In a floating-point (“FP”) MAC operation, a FP number can be expressed as a sign, a mantissa, or significand, and an exponent, which is an integer power to which the base is raised. A product of two FP numbers, or factors, can be represented by the product of the mantissas (“product mantissa”) and sum of exponents of the factors. The sign of the product can be determined according to whether the signs of the factors are the same. In a binary floating-point (“FP”) MAC operation, which can be implemented in digital devices such as digital computers and/or digital CIM circuits, each FP factor can be stored as a mantissa of a bit-width (number of bits), a sign (e.g., a single sign bit, S (1_{b} for negative; 0 for non-negative), the sign for the mantissa, and the floating-point number being (−1)^{S}), and an integer power to which the base (i.e., 2) is raised. In some representation schemes, a binary FP number is normalized, or adjusted such that the mantissa is greater than or equal to 1_{b} but less than 10_{b}. That is, the integer portion of a normalized binary FP number is 1_{b}. In some hardware implementations, the integer portion (i.e., 1_{b}) of a normalized binary FP number is a hidden bit, i.e., not stored, because 1_{b} is assumed. In some representation schemes, A product of two FP numbers, or factors, can be represented by the product mantissa, a sum of the exponent of the factors, and a sign, which can be determined, for example, by comparing the signs of the factors, or by a sum of the sign bits or the least significant bit (“LSB”) of the sum.

To implement accumulation part of a MAC operation, in some conventional procedures, the product mantissas are first aligned. That is, if necessary, at least some of the product mantissas are modified by appropriate orders of magnitude so that the exponents of the product mantissas are all the same. For example, product mantissas can be aligned to have all exponents be the maximum exponent of pre-alignment product mantissas. Aligned mantissas can then be added together (algebraic sum) to form the mantissa of the MAC output, with the maximum exponent of pre-alignment product mantissas.

To improve MAC operations, according to some embodiments disclosed in the present disclosure, mantissas of the weight values, or weights, used in MAC operations are aligned by adjusting the mantissas, such as shifting the bit patterns off at least some of the mantissas such that the weight values have the same exponent, such as the maximum exponent of the weight values. The aligned mantissas of the weight values then multiply with mantissas of input values to form mantissa products. The mantissa products are then aligned, you've necessary, and summed to form a partial sum mantissa, which is then combined with the exponent to form a partial sum floating-point output to be used in further computation process. In some embodiments, the mantissas of the input values are also aligned prior to multiplication with the aligned mantissas of the weight values. The exponents of the mantissa products in this case are thus the same and the mantissa products need not be aligned to be summed.

In some embodiments, weight values can be divided into subgroups, and the MAC operations described above, with mantissas of the weight values aligned prior to the multiplication with input values, are used for at least one subgroup. In some embodiments, the MAC operations described above are applied to at least two subgroups, resulting in at least two respective partial sum floating-point outputs of different exponents. The mantissas of the outputs are then aligned with each other before the partial sum floating-point outputs are summed together.

In some embodiments, the aligned mantissas of the weight values are stored in the memory device, such as a memory array. The stored aligned mantissas of the weight values are then retrieved from the memory device to be multiplied with the respective input values. In some embodiments, the aligned mantissas of the weight values are generated “offline,” i.e., generated prior to run-time, e.g., prior to input activations being applied to a trained neural work. In some AI applications, an AI system, such as one employing an artificial neural network, is first “trained” by relating training date to output date to iteratively determine the weight values for the nodes in the network. Once the training is completed, the weight values do not need to be changed and can be prestored in the memory units in the network. Different input date sets can be applied to the neural network having the same set of weight values. In some embodiments, the static weight values can be stored in the form of aligned mantissas within at least a subgroup of weight values.

Thus, generally, in accordance with some embodiments, a computing method includes, for a set of products, each of a respective pairs of a first and a second floating-point operands, such as a weight value (or “weight”) and an input value (or “input activation”), respectively, in multiply-accumulate operations, each of the floating-point operands having a respective mantissa and exponent, aligning the exponents of first floating-point operands based on a maximum exponent of the first floating-point operands to generate a shared exponent; modifying the mantissas of the first floating-point operands based on the shared exponent to generate respective adjusted mantissas of the first floating-point operands; generating mantissa products, each based on the mantissa of a respective one of the second floating-point operands and a respective one of the adjusted first mantissas; summing the mantissas products to generate a mantissa product partial sum; and combining the shared exponent and the product mantissa partial sum. The adjusted mantissas of the first floating-point operands can be stored in a memory device and retrieved from the memory device for the mantissa product generation. The product mantissa partial sum can be used in a neural network system. The multiplication can be performed in a computer-in-memory macro (“CIM macro”), and the alignment of the mantissas of at least one of the first and second floating-point operands can be carried out offline and the adjusted (aligned) mantissas pre-stored in the CIM macro.

In further embodiments, a computer method includes the steps described above and further includes, before the multiplication step, aligning the exponents of second floating-point operands (e.g., input activations) based on a maximum exponent of the second floating-point operands to generate a shared exponent; modifying the mantissas of the second floating-point operands based on the shared exponent to generate respective adjusted mantissas of the second floating-point operands. The summing of the mantissa products is then carried out by directly summing the mantissas of the mantissa products without any further alignment.

In some embodiments, a computing method includes, for a set of products, each of a respective pairs of a first and a second floating-point operands, such as an input activation and a weight value, respectively, in multiply-accumulate operations, each of the floating-point operands having a respective mantissa and exponent, aligning the exponents of first floating-point operands based on a maximum exponent of the first floating-point operands to generate a shared exponent; modifying the mantissas of the first floating-point operands based on the shared exponent to generate respective adjusted mantissas of the first floating-point operands; generating mantissa products, each based on the mantissa of a respective one of the second floating-point operands and a respective one of the adjusted first mantissas; modifying the mantissa products based on the shared exponent to generate respective adjusted mantissas mantissa products; summing the adjusted mantissa products to generate a mantissa product partial sum; and combining the shared exponent and the product mantissa partial sum. The adjusted mantissas of the first floating-point operands can be saved in a memory device and retrieved from the memory device for the mantissa product generation. The product mantissa partial sum can be used in a neural network system.

According to some embodiments, a device for carrying out the method described above include one or more digital circuits, such as microprocessors, shift registers, binary multipliers and adders, and comparators, configured to implement the steps of the method, and memory devices configured store the output of the digital circuits. In some embodiments, mantissa adjustments are carried out by shifting the mantissas stored in registers. In some embodiments, the multiplication is carried out in CIM macros, where the mantissas of the first floating-point numbers (e.g., weight values) are stored in a CIM memory array connected to a logic circuit, and the mantissas of the second floating-point number (e.g., input activations) are applied to the logic circuit, which outputs digital signal indicative of products of the mantissas.

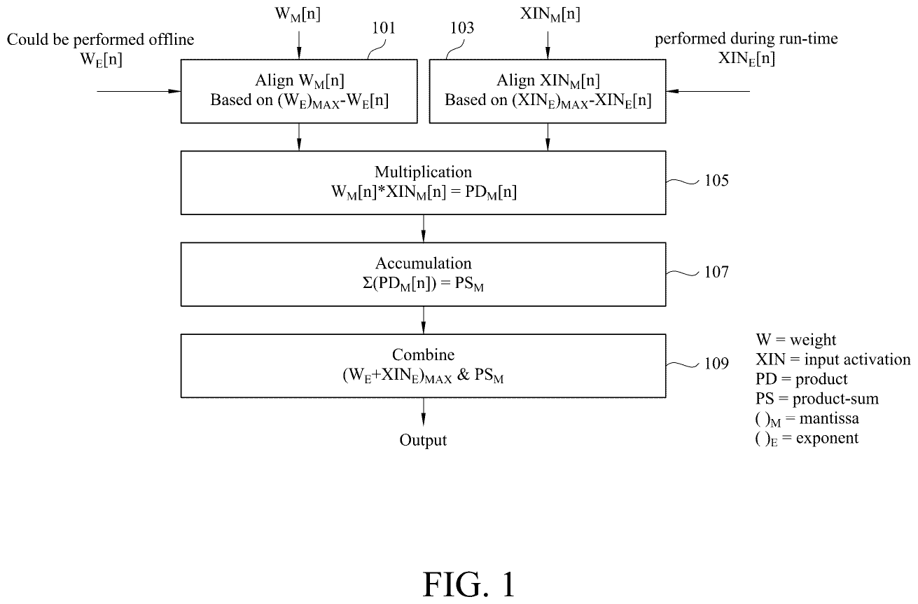

Specific embodiments are described in more detail below with reference to the drawings. In one example, as outlined in FIG. 1, for a set of weight mantissas, W_{M}[n], of weight values W[n] and corresponding set of input mantissas, XIN_{M}[n], of input activations XIN[n], with exponent W_{E}[n] and XIN_{E}[n], respectively, W_{M}[n] are aligned with each other 101 based on the difference between the exponents W_{E}[n]. In some embodiments, W_{M}[n] are adjusted according to the difference, ΔW_{E}[n], between the maximum exponent, (W_{E})_{MAX} and W_{E}[n], i.e., based on ΔW_{E}[n]=(W_{E})_{MAX}−W_{E}[n]. The mantissa, W_{M}[n] are each multiplied by the base (i.e., 2) raised to the (ΔW_{E}[n])-th power, so that all weight mantissas in the set have the same, maximum exponent after the modifications. The multiplication of a mantissa by the base raised to the (ΔW_{E}[n])-th power can be implemented by shifting, for example using a shift register, the mantissa to the right by ΔW_{E}[n] bits. That is, the mantissa is divided by 2\hat{ }ΔW_{E}[n], and the exponent is effectively increased by ΔW_{E}[n] and become the maximum exponent. The weight mantissas are then post-alignment weight mantissas.

Similarly, the input mantissas, XIN_{M}[n], are aligned with each other 103 based on the difference between the exponents XIN_{E}[n]. In some embodiments, XIN_{M}[n] are adjusted according to the difference, ΔXIN_{E}[n], between the maximum exponent, (XIN_{E})_{MAX} and XIN_{E}[n], i.e., based on ΔXIN_{E}[n]=(XIN_{E})_{MAX}−XIN_{E}[n]. The input mantissas are then post-alignment input mantissas.

Next, each point-alignment weight mantissa is multiplied 105 by the respective post-alignment input mantissa to generate a mantissa product, PD_{M}[n]=W_{M}[n]*XIN_{M}[n]. The mantissa products are then summed, or accumulated, 107 to generate a product-sum mantissa, PS_{M}=> (PD_{M}[n]). The product sum in this example is an algebraic sum, i.e., a sum of the product mantissas with their signs based on the signs of the respective weight mantissa and input mantissa. The product sum mantissa, PS_{M} is then combined 109 with the exponent, PS_{E}, of the product-sum, PS, to generate a floating-point output, which can be, for example, a partial sum as a part of an input activation for a deeper layer, such as a hidden layer, in an artificial neural network. In this example, “combine” means providing both the product-sum mantissa, PS_{M}, and product-sum exponent, PS_{E}, in the computation system, such as an artificial neural network, in a way that can be utilized by the system for subsequent operation. For example, PS_{M} and PS_{E} can be combined to form a floating-point number in the FP16 format, i.e., a 16-bit number including a single sign bit, PSs, followed by a 5-bit exponent, PS_{E}, followed by a 10-bit mantissa, PS_{M}. In this example, because all weight exponents are (W_{E})_{MAX}, and all input exponents are (XIN_{E})_{MAX}, the product-sum exponent, PS_{E}, is the same for all weight-input products and is (W_{E})_{MAX}+(XIN_{E})_{MAX}, or (W_{E}+XIN_{E})_{MAX}. Thus, no mantissa alignment needs to be carried out for the accumulation step 107.

In some embodiments, the alignment of the mantissas of at least one of the sets of floating-point number, such as weight values, are performed “offline,” i.e., generated prior to run-time, e.g., prior to input activations being applied to a trained neural work, while the alignment of the mantissas of another one of the sets of floating-point number, such as input activations, are performed during run-time. For example, in certain artificial intelligence (“AI”) and machine learning (“ML”) applications, more specifically deep-learning applications, models are implemented in artificial neural networks, in which MAC operations are carried out in successive layers of nodes, with weight values stored in the nodes and each layer generating the input activations for the next deeper layer. During the training phase of a ML model, training data sets are propagated through the layers of neural network, and the weight values are adjusted iteratively to improve the decision-making capability of the model. Once the model is trained, weight values are determined and can be stored in the memory devices in neural networks. The trained weight values, i.e., those used in trained neural networks, remain fixed, independent of data input. Thus, in some embodiments, the alignment of trained weight mantissas is carried out offline and prestored in the memory devices in neural networks.

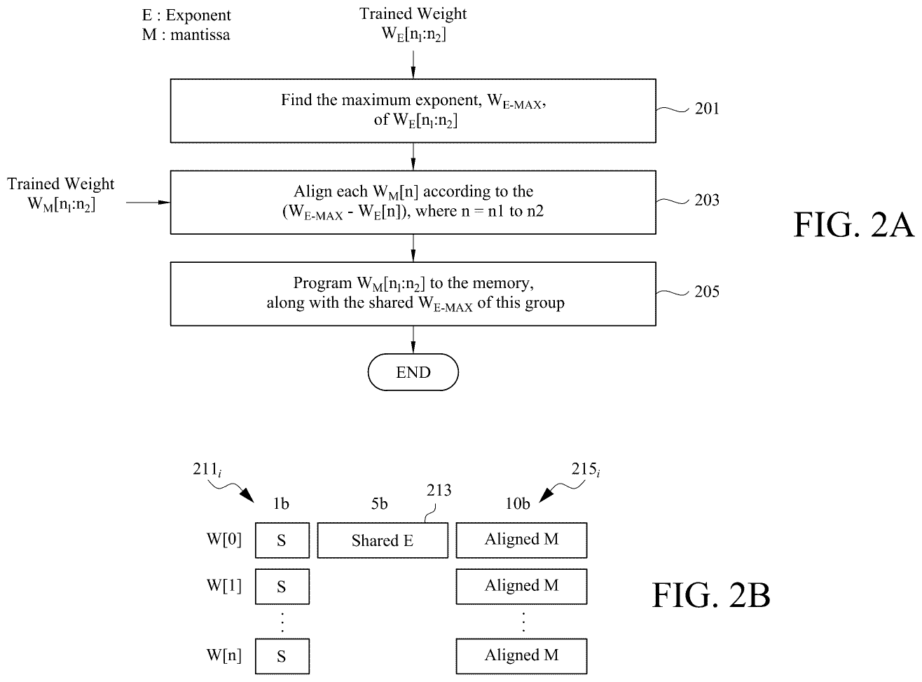

In some embodiments, as shown in FIG. 2A, the maximum exponent, W_{E-MAX}, of the trained weights, W_{E}[n₁:n₂], is determined 201, for example by a comparator or microprocessor. The maximum exponent, W_{E-MAX}, is used to align 203 the mantissas of the trained weights, W_{M}[n₁:n₂], as described above. The aligned mantissas and W_{E-MAX} are then stored, or programmed 205, into the memory devices of a neural network. Programming aligned trains weights into memory devices, such as CIM memory arrays or CIM macros, has the advantage of reducing amount of data transfer between the computing unit and off-macro memory. Because all weight values for n=n₁ through n₂ share the same exponent W_{E-MAX}, only W_{E-MAX} needs to be stored, and stored only once, in the memory. As shown in FIG. 2B, trained and aligned weight values can be stored as respective sign bits 211ᵢ, respective aligned mantissas 215ᵢ, and a shared exponent 213, i.e., W_{E-MAX}. Because only the shared exponent is stored, savings in storage are achieved.

As shown in FIGS. 2A and 2B, in some embodiments, mantissa alignment is not done for all weight values in a MAC operation, such as a MAC operation for an entire neural network layer, to obtain a single shared exponent. Mantissa alignment can be done for a subset (i=n₁ through n₂) of weight values in a MAC operation. Furthermore, in some embodiments, mantissa alignment can be done for multiple subsets of weight values in a MAC operation to obtain a shared exponent for each subset. The weight values can be different from each other.

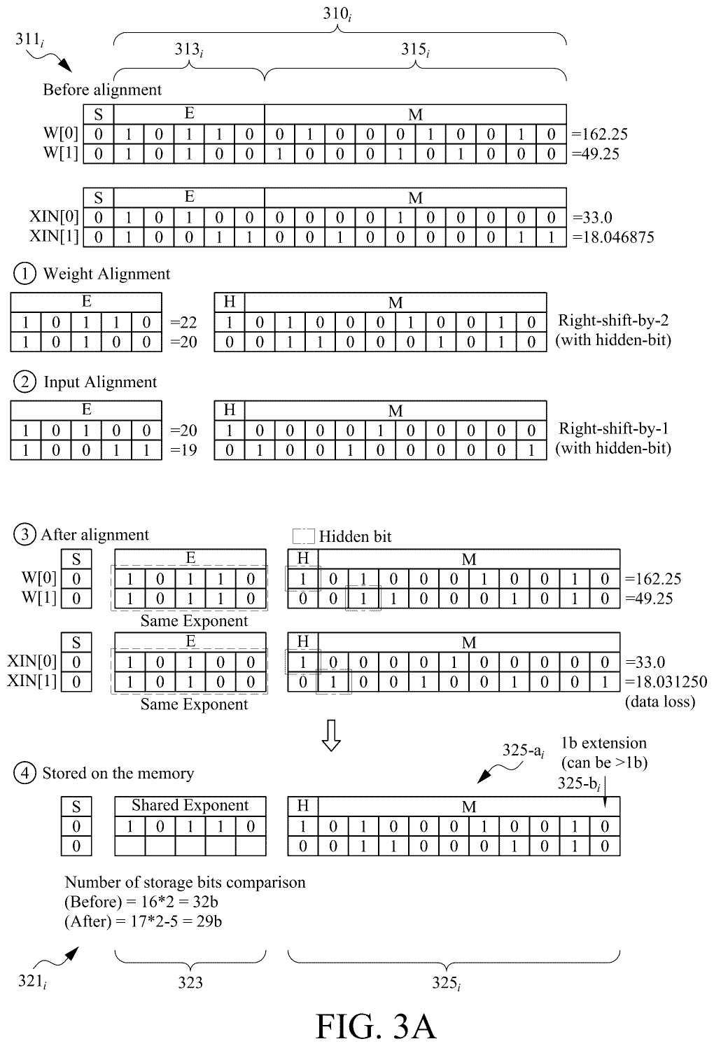

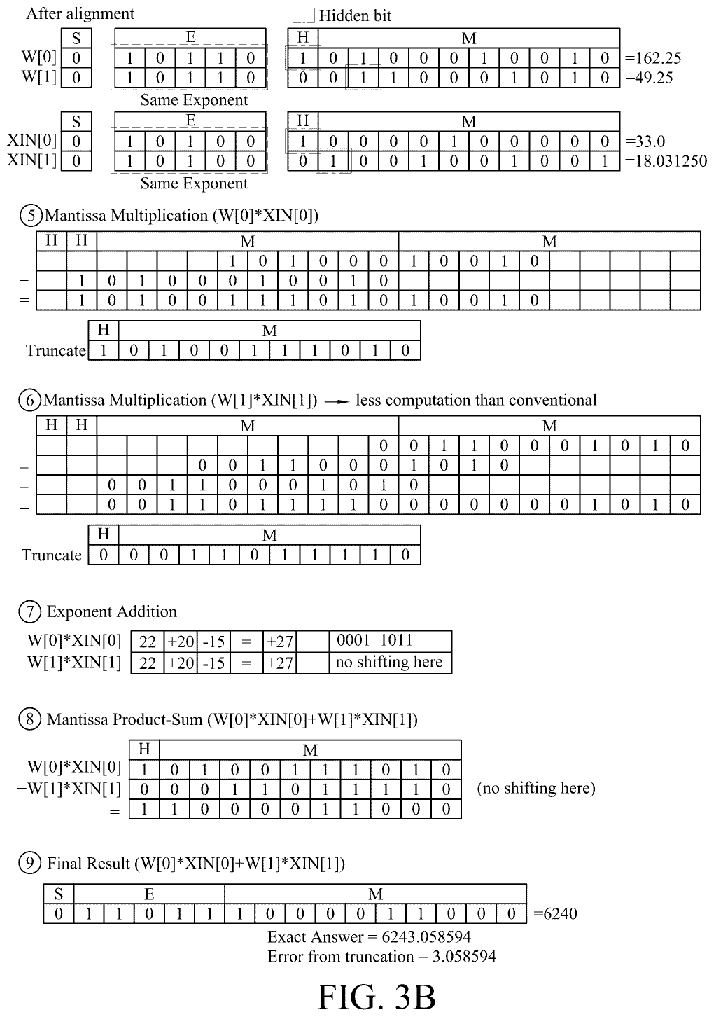

An example of weight alignment 101 and input alignment 103 is illustrated for a MAC operation involving two weight values, W[i], and two input activations, XIN[i], i=0, 1, is shown in FIGS. 3A and 3B. The output of the MAC operation in this example is W[0]×XIN[0]+W[1]×XIN[1]. Initially, the weight values and input activations are stored in memory devices, such as registers, in 16-bit floating point, or FP16, format: Each number is stored as a single sing bit(S) 311ᵢ, a 5-bit exponent (E) 313ᵢ, and a 10-bit mantissa (M) 315ᵢ. Note that each mantissa further includes a hidden bit 1_{b} as the most-significant bit “MSB.” In this example, as indicated at labels (1) and (2), respectively, the maximum weigh exponent is 22_{d}=10110_{b}, the greater of the two weight exponents 22_{d} and 20_{d}, and the maximum input exponent is 20_{d}=10011_{b}, the greater of the two weight exponents 20_{d} and 19_{d}. Therefore, to have the weight exponents for both weight values be the maximum exponent, 10110_{b}, the mantissa, W_{M}[1], of the weight value having the smaller initial exponent, is right-shifted by two bits, effectively multiplied by 2\hat{ }ΔW_{E}[n], or 2². Likewise have the input exponents for both input activations be the maximum exponent, 10011_{b}, the mantissa, XIN_{M}[1], of the input activation having the smaller initial exponent, is right-shifted by on bit, effectively multiplied by 2\hat{ }ΔXIN_{E}[n], or 2¹. The result, as shown at label (3), is floating-point numbers with shared weight and input exponents, respectively and post-alignment mantissas, with the mantissas that have been right-shifted now including the previously hidden bits but with the previously least significant bit(s) truncated, resulting some data loss if the truncated bits include any 1_{b}'s.

Next, the post-alignment weights, as shown at label (4), are stored with the shared exponent. That is, W[0] and W[1] are each stored as a single sing bit(S) 321; and a 11-bit mantissa (M) 325ᵢ, but only a single, shard exponent 323 is stored. Note that the post-alignment mantissa 325; in this example do not have include any bit that is hidden: The hidden bits in the initially stored weight values are now stored because the MSB of any shifted mantissa is now 0, and it can no longer be assumed that the MSBs of all mantissas are 1_{b}. Thus, the MSB 325-aᵢ of the weigh mantissas must be stored, it takes an extra bit, or extension 325-bᵢ, to store post-alignment mantissas. The extension 325-bᵢ in this example is one bit and preserves the data in the un-shifted mantissas, but can be other lengths. For example, the extension can be two or three-bit long to reduce or data loss in the shifted mantissas due to truncation.

The use of shared exponent can result in savings in storage. For example, in the example shown at label (4) in FIG. 3A, the total number of bits used to store pre-alignment weight values is 16×2=32; the total number of bits used to store post-alignment weight values is 17×2−5=29, a saving of three bits.

Following weigh alignment, as shown at labels (5) and (6) in FIG. 3B, respectively, multiplication of post-alignment weight mantissas by respective post-alignment input mantissas (W_{M}[0]×XIN_{M}[0] and W_{M}[1] xXIN_{M}[1]) are carried out to generate respective mantissa products PD_{M}[n]. The result of each multiplication is truncated, in this example to an 11-bit product. In addition, the post-alignment exponents of the weight values and input activations are added together (taking into account any exponent bias, in this example 15), as shown at label (7). Note that in the case of W_{M}[1]×XIN_{M}[1] in this example, because the right-shifting of XIN_{M}[1] results in the 1_{b} at the LSB of un-shifted XIN_{M}[1] being lost, the subsequent multiplication step involves one fewer addition step as compared to multiplication without mantissa alignment. Thus, computational efficiency is improved, at an expense of data loss. With proper selection of computation parameters, such as the number of extension bits and size of subset of FP numbers subject to pre-multiplication alignment, optimal or acceptable compromises between computational efficiency and accuracy can be achieved.

Multiplication between weight values and respective input activations can be carried out in a multiply circuit, which can be any circuit capable of multiplying two digital numbers. For example, U.S. patent application Ser. No. 17/558,105, published as U.S. Patent Application Publication No. 2022/0269483 A1 and U.S. patent application Ser. No. 17/387,598, published as U.S. Patent Application Publication No. 2022/0244916 A1, both of which are commonly assigned with the present application and incorporated herein by reference, disclose multiply circuits used in CIM devices. In some embodiments, a multiply circuit includes a memory array that is configured to store one set of the FP numbers, such as weight values; the multiply circuit further includes a logic circuit coupled to the memory array and configured to receive the other set of FP numbers, such as the input values, and to output signals, each based on a respective stored number and input number, and being indicative of product of the stored number and respective input number.

Next, as shown at label (8), the mantissa product are accumulated, or added together, to generate a product sum mantissa, PS_{M} (W_{M}[0]×XIN_{M}[0]+W_{M}[1]×XIN_{M}[1]). Because the weight value and input activations are both post-alignment, the product sum exponent, i.e., the sum of exponents is the same for all products. Therefore, the accumulation operation does not involve any mantissa alignment or shifting.

Finally, as shown at label (9), the product sum mantissa, PS_{M}, and the product sum exponent, PS_{E}, are combined in storage as a floating-point number (FP16 in this example), to be used in further operations in AI process. In this example, the final result for (162.25×49.25+33.0×18.046875)_{d} is 6240_{d}, with an error of 3.058594 from the exact answer, 6243.058594. The error is the same as the error that would result from the MAC operation without pre-multiplication alignment.

As described above, due to the used of shared exponents in the weight values and input activations, savings in storage may be attained. The amount of savings depends on various factors, include the size of the group of weight values and input activations sharing the respective exponents and number of bits in the mantissa extensions. For example, storage bit reduction can be express as a ratio between the number of bits used with pre-multiplication mantissa alignment (“after”) and the number of bits used without pre-multiplication mantissa alignment (“before”):

$$Storage Bit Reduction = \frac{After}{Before} = \frac{{N}_{GP} * ( {FP}_{bit} + {EXT}_{bit} ) - ( {N}_{GP} - 1 ) * {EXP}_{bit}}{{N}_{GP} * {FP}_{bit}} \qquad ( 1 )$$

where,
N_{GP}=number of weight values or input activations grouped to share an exponent,
FP_{bit}=number of bits in floating point,
EXT_{bit}=number of mantissa extension bit, and
EXP_{bit}=number of exponent bits.

Equation (1) can be rearranged to give:

$$Storage Bit Reduction = \frac{{FP}_{bit} + {EXT}_{bit}}{{FP}_{bit}} - \frac{{EXP}_{bit}}{{FP}_{bit}} + \frac{{EXP}_{bit}}{{N}_{GP} \times {FP}_{bit}} \qquad ( 2 )$$

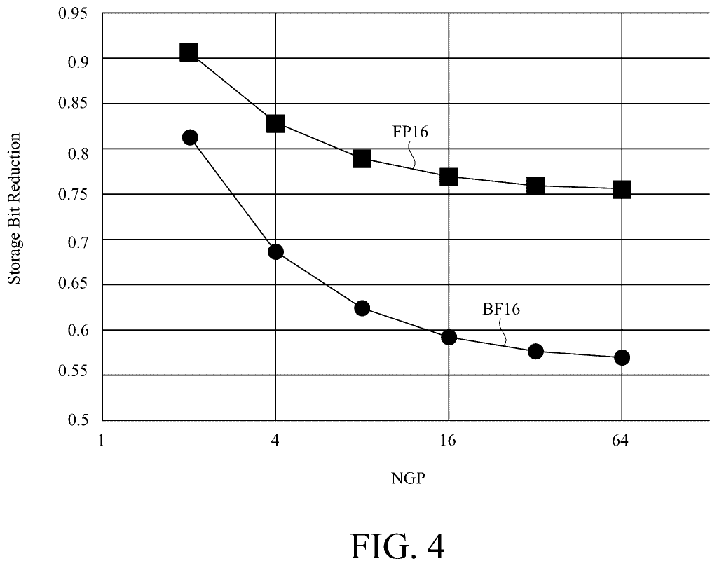

The dependency of the storage bit reduction on the group size, N_{GP}, is illustrated by the storage bit reduction vs. N_{GP} plots for the examples of FP16 and BF16 floating-point numbers in FIG. 4. As is evident from the plots, storage used decreases with group size and approaches a lower limit as group size becomes very large. In the examples shown in FIG. 4, the storage bit reduction approaches 0.75 for FP16, and 0.5625 for BP16.

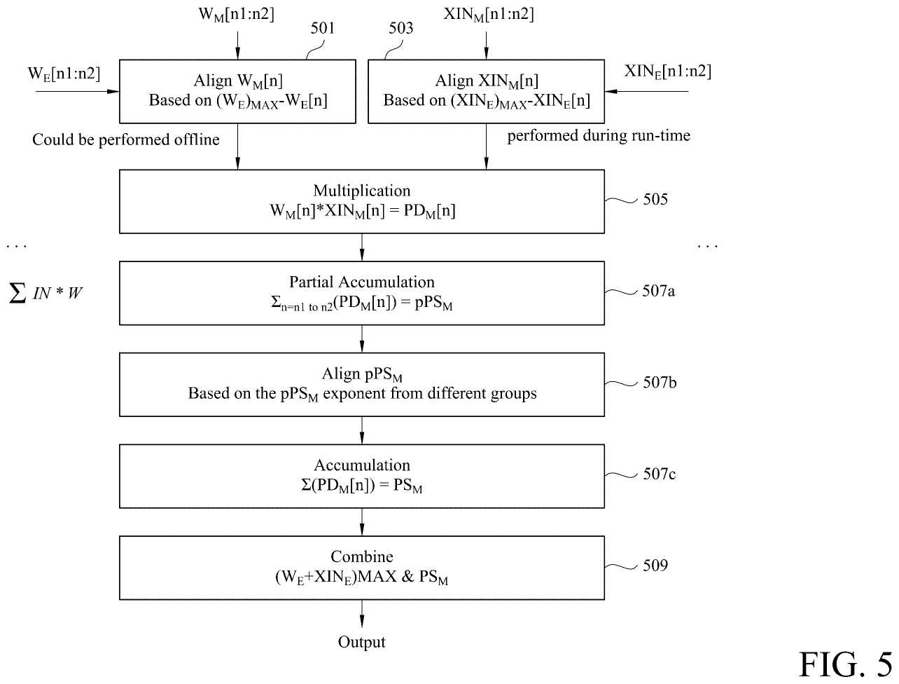

In some embodiments, such as the example illustrated in FIG. 5, weight values are divided into subgroups, and the MAC operations described above, with mantissas of the weight values aligned prior to the multiplication with input activations, are used for at least one subgroup. In the example illustrated in FIG. 5, input activations are also divided into subgroups corresponding to the weight value subgroups, and the MAC operations described above, with mantissas of the input activations aligned prior to the multiplication, are used for at least the subgroup corresponding to the weight value subgroup for which pre-multiplication alignment is carried out. In some embodiments, the MAC operations described above are applied to at least two subgroups of weight values and two corresponding subgroups of input activations, resulting in at least two respective partial sum floating-point outputs of different exponents, one for each of the subgroups. The mantissas of the partial sum outputs are then aligned with each other, in a procedure similar to those form aligning weight values and input activations, before accumulation.

In the example shown in FIG. 5, for each subgroup of weight values and input activations, the steps of weight alignment 501, input alignment 503, multiplication 505, and accumulation 507a are identical to the corresponding steps of weight alignment 101, input alignment 103, multiplication 105, and accumulation 107 in FIG. 1, except that instead of generating a product sum mantissa, PS_{M}, for the entire set of weight values and corresponding input activations, the process illustrated in FIG. 5 generates a partial product sum mantissa, pPS_{M}, for the each subset of weight values and corresponding input activations in the partial accumulation step 507a. The pPS_{M} are then aligned 507b with each other in a procedure similar to the alignment 501, 503 of weight values and input activations. The alignment procedure 507b also results in a maximum exponent of all subset; the maximum exponent is therefore the maximum exponent, (W_{E}+XIN_{E})_{MAX}, of the entire set. The aligned partial product sum mantissas pPS_{M} are then accumulated 507c to form the total product sum mantissa PS_{M} in a procedure similar to the partial accumulation step 507a for each subset. Finally, (W_{E}+XIN_{E})_{MAX} and pPS_{M} are combined 509 to generate the floating-point output in the same way as step 109 if FIG. 1.

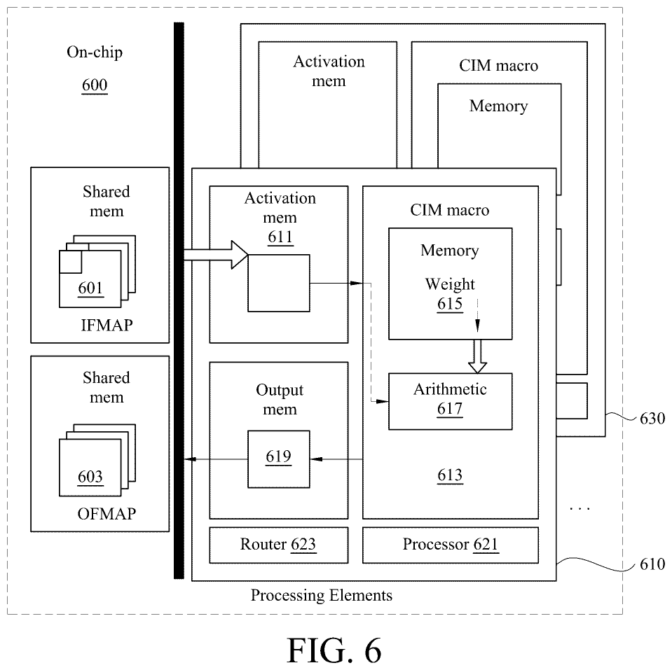

The MAC operations described above can be carried out in any suitable computing device. An example computing device 600 used in some embodiments is illustrated in FIG. 6. The computing device 600 can be an on-chip device and includes shared memory 601 for storing input data, including input activations and other data, shared output memory 603 for storing output data, including output of MAC operations, and various processing elements 610. Each processing element 610 in this example includes an activation memory 611, which can receive and store input activations from the input memory 601 and align the stored input activations as described above. Each Each processing element 610 in this example further includes a CIM macro 613, which includes a CIM memory array 615 for storing weight values, which in some embodiments include post-alignment weight mantissas with shared exponents generated offline. The CIM macro 613 in this example further includes an arithmetic circuit 617, which can be, for example, a logic circuit coupled to the CIM memory array 615 and configured to receive the stored post-alignment weight mantissa, and coupled to the activation memory 611 and configured to receive input activations, and to output signals, each being indicative of a product of respective weight mantissa and input mantissa. The arithmetic circuit 617 can further include circuitry for performing other processes, such as accumulation and combination, as described above. Each processing element 610 in this example further includes and output memory 619, which is connected to the CIM macro 613 and configured to receive output, such as product sums, from the CIM macro 613 to the share output memory 603. Each processing element 610 in this example further includes a processor, such as a microprocessor, programmed to perform various computational tasks, such as controlling the operations of other components of the processing element 610 and/or carrying out certain steps, such as alignment, accumulation and combination, of the MAC operation. Each processing element 610 in this example further includes a router 623 configured to manage data traffic.

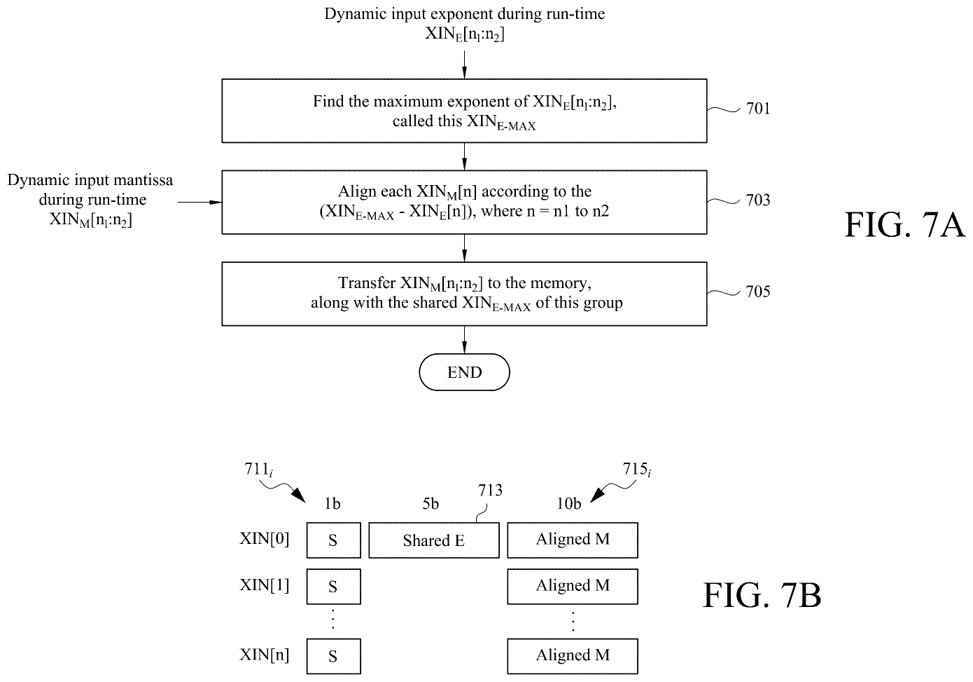

As shown in certain examples above, in some embodiments, both weight values and input activations can be aligned prior to multiplication in a MAC operation. In some embodiments, whereas the weight values are aligned offline pre-stored memory, such as in memory arrays in an AI system based on a trained model, the input activations can be aligned in runtime. For example, in a multi-layer deep-learning neural network, the output of each layer becomes the input activations for the next, deeper layer. The newly generated input activations can be aligned at run-time prior to being multiplied by the weight values stored in the next layer. The alignment process for input activations is similar to the one used for weight values in some embodiments. In an example shown in FIG. 7A, the maximum exponent, XIN_{E-MAX}, of the input activations, XIN_{E}[n₁:n₂], is determined 701, for example by a comparator or microprocessor. The maximum exponent, XIN_{E-MAX}, is used to align 703 the mantissas of the input activation, XIN_{M}[n₁:n₂], as described above. The aligned mantissas and XIN_{E-MAX} are then transferred 705 into memory devices, such as activation memory, to be using for subsequent multiplication. Because multiple input activations for n=n₁ through n₂ share the same exponent XIN_{E-MAX}, only XIN_{E-MAX} needs to be stored, and stored only once, in the memory. As shown in FIG. 7B, aligned input activations can be stored as respective sign bits 711ᵢ, respective aligned mantissas 715ᵢ, and a shared exponent 713, i.e., XIN_{E-MAX}. Because only the shared exponent is stored, savings in storage are achieved.

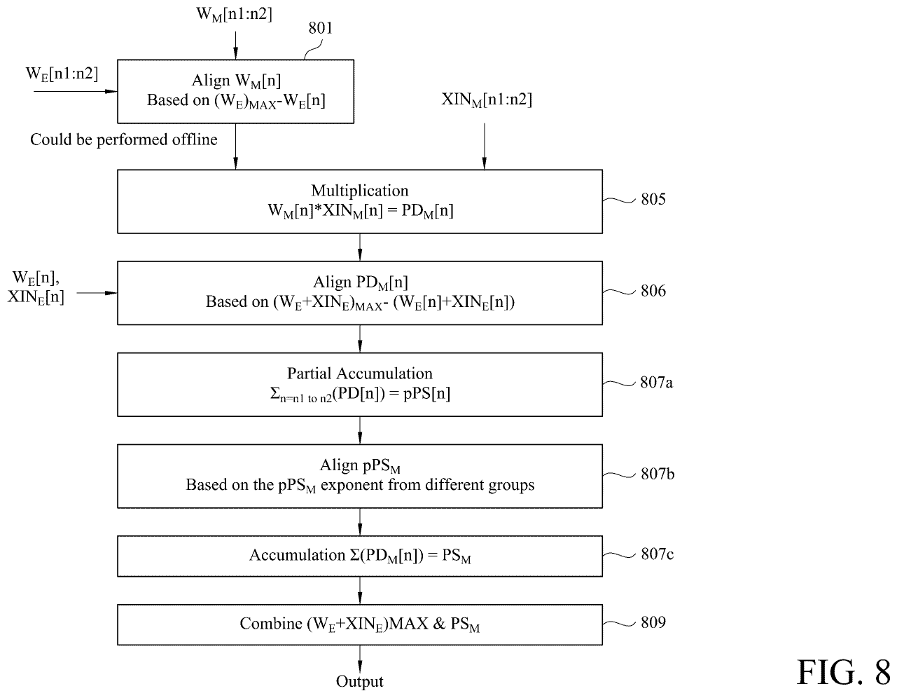

In some embodiments, only weigh values are aligned, possibly offline and stored in the memory arrays of a computing device operating on a trained model, prior to multiplication with input activations. In the example process shown in FIG. 8, weight values of subset of weight values are aligned 801 in a process similar to the alignment step 501 in FIG. 5. No alignment of the input activation is carried out for the corresponding subgroup of input activations. Next, the aligned weigh values are multiplied 805 with the input activations to generate corresponding mantissa products, PD_{M}[n], in a similar way as the multiplication step 505 in FIG. 5. Next, PD_{M}[n] are aligned 806 based on the maximum exponent sum, (W_{E}+XIN_{E})_{MAX}, to generate aligned mantissa products in a similar manner as the alignment step 801 for weight values. Next, a partial product sum mantissa, pPS_{M}, for the each subset of weight values and corresponding input activations is generated in the partial accumulation step 807a, similar to the partial accumulation step 507a in FIG. 5. The pPS_{M} are then aligned 807b with each other in a procedure similar to the alignment step 507b. The alignment procedure 507b also results in a maximum exponent of all subset; the maximum exponent is therefore the maximum exponent, (W_{E}+XIN_{E})_{MAX}, of the entire set. The aligned partial product sum mantissas pPS_{M} are then accumulated 807c to form the total product sum mantissa PS_{M} in a procedure similar to the partial accumulation step 807c for each subset. Finally, (W_{E}+XIN_{E})_{MAX} and pPS_{M} are combined 809 to generate the floating-point output in the same way as step 509 of FIG. 5.

Certain examples described in this disclosure can result in energy savings due to enhanced bitwise sparsity of weight values and input activations after alignment prior to multiplication in MAC operations, as reduced number of 1_{b}'s in shifted mantissas reduces the number of operations in the multiplication step. In other aspects, the use of shared exponents of post-alignment floating-point weight values and input activations results in storage savings. Computing processes can thus be made more efficient without losing accuracy.

In sum, according to some embodiments a computing method includes: for a first set of floating-point numbers and second set of floating-point numbers, each having a respective mantissa and exponent, aligning the mantissas of the first set of floating-point numbers based on a maximum exponent of the first set of floating-point numbers to generate a first common exponent; storing the first set of post-alignment mantissas in a memory device; generating a first set of mantissa products, each based on the mantissa of a respective one of the second set of floating-point numbers and a respective one of the post-alignment first mantissas retrieved from the memory device; an accumulation step, including summing the first mantissa products to generate a first mantissa product partial sum and to generate a first product partial sum exponent based on the first common exponent and the exponents of the second plurality of floating-point numbers; and combining the first product partial sum exponent and the first mantissa product partial sum to form an output floating-point number.

According to further embodiments, a computing method includes: for a first set of weight values, each having a respective weight mantissa and weight exponent, aligning the weight mantissas based on a maximum weight exponent of the first set of weight values to generate a first common weight exponent; storing the post-alignment weight mantissas in a respective first set of memory units in an artificial neural network; providing a first set of input activations to respective inputs of a first multiply circuit in the artificial neural network, each of the first set of input activations having a respective input mantissa and input exponent; generating, using the first multiply circuit, first set of mantissa products, each based on respective weight mantissa and respective input mantissa; an accumulation step, comprising summing the first mantissa products to generate a first mantissa product partial sum and to generate a first product partial sum exponent based on the common weight exponent and the exponents of the first set of input activation; and combining the first product partial sum exponent and the first mantissa product partial sum to form a first output floating-point number.

According still further embodiments, a computing device includes: a memory array comprising a set of memory units, each configured to store a respective mantissa of a respective weight value having a common exponent; a first storage configured to store the common exponent; a first digital circuit configured to receive a set of input activations, each having a respective mantissa and exponent, and a multiply circuit configured to retrieve from the memory array the mantissas of the respective weight values and generate products of the retrieved mantissas and the mantissas of the respective received input activations; a summing circuit configured to add the products to generate a product sum mantissa and generate a product sum exponent based on the exponents of the received input activations and the common exponent stored in the first storage; and a second storage having a mantissa portion configured to store the product sum mantissa and an exponent portion configured to store the exponent of the product exponent.

This disclosure outlines various embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A computing method, comprising:
for a first plurality of floating-point numbers and second plurality of floating-point numbers, each having a respective mantissa and exponent, aligning the mantissas of the first plurality of floating-point numbers based on a maximum exponent of the first plurality of floating-point numbers to generate a first common exponent;
storing the first plurality of post-alignment mantissas in a memory device;
generating a first plurality of mantissa products, each based on the mantissa of a respective one of the second plurality of floating-point numbers and a respective one of the post-alignment first mantissas retrieved from the memory device;
an accumulation step, comprising summing the first mantissa products to generate a first mantissa product partial sum and to generate a first product partial sum exponent based on the first common exponent and the exponents of the second plurality of floating-point numbers; and
combining the first product partial sum exponent and the first mantissa product partial sum to form an output floating-point number.

2. The computing method of claim 1, further comprising generating a second plurality of mantissa products, each based on mantissa of a respective one of a third plurality of floating-point numbers and a respective one of the adjusted first mantissas retrieved from the memory device.

3. The computing method of claim 1, wherein:
the aligning the mantissas of the first plurality of floating-point numbers comprises modifying the mantissas of the first plurality of floating-point numbers based on the first common exponent to generate a first plurality of respective adjusted mantissas; and
generating a first plurality of mantissa products comprises generating a first plurality of mantissa products, each based on the mantissa of a respective one of the second plurality of floating-point numbers and a respective one of the adjusted first mantissas retrieved from the memory device.

4. The computing method of claim 1, further comprising:
aligning the mantissas of the second plurality of floating-point number based on a maximum exponent of the second plurality of floating-point numbers to generate a second common exponent,
wherein the generating a first product partial sum exponent based on the first common exponent and the exponents of the second plurality of floating-point numbers comprises generating a first product partial sum exponent based on the first common exponent and the second common exponents.

5. The computing method of claim 1, further comprising storing the first common exponent in a first storage, wherein the generating a first product partial sum exponent based on the first common exponent and the exponents of the second plurality of floating-point numbers comprises generating a first product partial sum exponent based on the first common exponent stored in the first storage and the exponents of the second plurality of floating-point numbers.

6. The computing method of claim 1, further comprising:
for a third plurality of floating-point numbers and fourth plurality of floating-point numbers, each having a respective mantissa and exponent, aligning the mantissas of the third plurality of floating-point numbers based on a maximum exponent of the third plurality of floating-point numbers to generate a second common exponent;
storing the third plurality of post-alignment mantissas in a memory device; and
generating a second plurality of mantissa products, each based on the mantissa of a respective one of the fourth plurality of floating-point numbers and a respective one of the post-alignment third mantissas retrieved from the memory device;
the accumulating step further comprising:
summing the second plurality of mantissa products to generate a second mantissa product partial sum and to generate a second mantissa product partial sum exponent based on the second common exponent and the exponents of the fourth plurality of floating-point numbers;
aligning the mantissas of the first and second mantissa product partial sums based on a maximum exponent of the first and second product partial sums to generate a common partial sum exponent; and
summing the post-alignment mantissas of the first and second mantissa product partial sums to generate a mantissa product sum;
wherein the combining step comprises combining the common partial sum exponent and the product mantissa sum to form an output floating-point number.

7. The computing method of claim 6, further comprising:
aligning the mantissas of the second plurality of floating-point number based on a maximum exponent of the second plurality of floating-point numbers to generate a third common exponent,
wherein the generating a first product partial sum exponent based on the first common exponent and the exponents of the second plurality of floating-point numbers comprises generating a first product partial sum exponent based on the first common exponent and the third common exponents.

8. The computing method of claim 5, further comprising:
aligning the mantissas of the second plurality of floating-point number based on a maximum exponent of the second plurality of floating-point numbers to generate a second common exponent,
wherein the generating a first product partial sum exponent based on the first common exponent and the exponents of the second plurality of floating-point numbers comprises generating a first product partial sum exponent based on the first common exponent and the second common exponents; and
storing the second common exponent in a second storage, wherein the generating a first product partial sum exponent based on the first common exponent and the exponents of the second plurality of floating-point numbers comprises generating a first product partial sum exponent based on the first common exponent stored in the first storage and the second common exponent stored in the second storage.

9. A computing method, comprising:
for a first plurality of weight values, each having a respective weight mantissa and weight exponent, aligning the weight mantissas based on a maximum weight exponent of the first plurality of weight values to generate a first common weight exponent;
storing the post-alignment weight mantissas in a respective first plurality of memory units in an artificial neural network;
providing a first plurality of input activations to respective inputs of a first multiply circuit in the artificial neural network, each of the first plurality of input activations having a respective input mantissa and input exponent;
generating, using the first multiply circuit, first plurality of mantissa products, each based on respective weight mantissa and respective input mantissa;
an accumulation step, comprising summing the first mantissa products to generate a first mantissa product partial sum and to generate a first product partial sum exponent based on the common weight exponent and the exponents of the first plurality of input activation; and
combining the first product partial sum exponent and the first mantissa product partial sum to form a first output floating-point number.

10. The computing method of claim 9, further comprising storing the first common weight exponent in a first storage, wherein the generating a first product partial sum exponent based on the first common weight exponent and the first plurality of input activations comprises generating a first product partial sum exponent based on the first common exponent stored in the first storage and the exponents of the first plurality of input activations.

11. The computing method of claim 9, further comprising:
aligning the input mantissas of the first plurality of input activations based on a maximum input exponent of the first plurality of input activations to generate a common input exponent,
wherein the generating a first product partial sum exponent based on the common weight exponent and the input exponents of the first plurality of input activations comprises generating a first product partial sum exponent based on the common weight exponent and the common input exponents.

12. The computing method of claim 9, further comprising:
providing a second plurality of input activations to the respective inputs of the multiply circuit in the artificial neural network, each of the second plurality of input activations having a respective input mantissa and input exponent;
generating, using the multiply circuit, a second plurality of mantissa products, each based on respective weight mantissa and respective input mantissa of a respective one of the second plurality of input activations.

13. The computing method of claim 9, further comprising:
for a second plurality of weight values, each having a respective weight mantissa and weight exponent, aligning the weight mantissas based on a maximum weight exponent of the first plurality of weight values to generate a second common weight exponent;
storing the post-alignment weight mantissas of the second plurality of weight values, in a respective second plurality of memory units in an artificial neural network;
providing a second plurality of input activations to respective inputs of a second multiply circuit in the artificial neural network, each of the second plurality of input activations having a respective input mantissa and input exponent, one of the second plurality of input activations being the first output floating-point number;
generating, using the second multiply circuit, a second plurality of mantissa products, each based on respective post-alignment weight mantissas of the second weight values and respective input mantissa of the second plurality of input activations.

14. The computing method of claim 9, wherein aligning the weight mantissas based on a maximum weight exponent of the first plurality of weight values to generate a first common weight exponent comprises:
aligning a first subset of the weight mantissas based on a maximum weight exponent of the respective first subset of the first plurality of weight values to generate a first common weight exponent;
aligning a second subset of the weight mantissas based on a maximum weight exponent of the respective second subset of the first plurality of weight values to generate a second common weight exponent; and
generating, using the first multiply circuit, first plurality of mantissa products, each based on respective weight mantissa and respective input mantissa of the first subset of first weight values, and second plurality of mantissa products, each based on respective weight mantissa and respective input mantissa of the second subset of first weight values;
wherein the accumulation step comprises:
summing the first plurality of mantissa products to generate a first mantissa product partial sum and summing the second plurality of mantissa products to generate a second mantissa product partial sum; and
summing the first and second mantissa product partial sums to generate a mantissa product sum.

15. The computing method claim 14, wherein the summing the first and second mantissa product partial sums comprises aligning the first and second aligning mantissa product partial sums based on a maximum exponent of first and second product partial sums.

16. A computing device, comprising:
a memory array comprising a plurality of memory units, each configured to store a respective mantissa of a respective weight value having a common exponent;
a first storage configured to store the common exponent;
a first digital circuit configured to receive a plurality of input activations, each having a respective mantissa and exponent, and;
a multiply circuit configured to retrieve from the memory array the mantissas of the respective weight values and generate products of the retrieved mantissas and the mantissas of the respective received input activations;
a summing circuit configured to add the products to generate a product sum mantissa and generate a product sum exponent based on the exponents of the received input activations and the common exponent stored in the first storage; and
a second storage having a mantissa portion configured to store the product sum mantissa and an exponent portion configured to store the exponent of the product exponent.

17. The computing device of claim 16, wherein:
the first digital circuit being further configured to adjust the mantissas of the received input activation so that the received input activations have a common exponent;
the computing device further comprising a third storage configured to store the common exponent of the received input activations; and
the summing circuit is configured to add the products to generate a product sum mantissa and generate a product sum exponent based on the common exponent, stored in the third storage, of the received input activations and the common exponent, stored in the first storage, of the weight values.

18. The computing device of claim 16, further comprising a second digital circuit configured to receive the products from the multiply circuit and adjust the mantissas of the product so that the products have a common exponent,
wherein the summing circuit is configured to add the mantissas of the adjusted products to generate a product sum mantissa and generate a product sum exponent based on the common exponent of the products and the common exponent, stored in the first storage, of the weight values.

19. The computing device of claim 17, further comprising a second digital circuit configured to receive the products from the multiply circuit and adjust the mantissas of the product so that the products have a common exponent,
wherein the summing circuit is configured to add the mantissas of the adjusted products to generate a product sum mantissa and generate a product sum exponent based on the common exponent of the products and the common exponent, stored in the first storage, of the weight values.

20. The computing device of claim 16, wherein:
the memory array is configured to maintain the mantissas of respective weight values;
the first digital circuit being configured to receive a first plurality of input activations, each having a respective mantissa and exponent, and a second plurality of input activations, each having a respective mantissa and exponent; and
the multiply circuit configured to retrieve from the memory array the maintained mantissas of the respective weight values and generate:
a first plurality of products of the retrieved mantissas and the mantissas of the respective received first plurality of input activations; and
a second plurality of products of the retrieved mantissas and the mantissas of the respective received second plurality of input activations.
